(19) United States
(12) Patent Application Publication
(10) Pub. No.: US 2015/0116980 A1
(43) Pub. Date: Apr. 30, 2015

(54) ILLUMINATION SYSTEM

(71) Applicants: FORMOSA EPITAXY INCORPORATION, TAOYUAN COUNTY (TW); DJ AUTO COMPONENTS CORP., TAOYUAN COUNTY (TW)

(72) Inventors: JEN-CHIH LI, TAOYUAN COUNTY (TW); LUNG-KUAN LAI, TAOYUAN COUNTY (TW); CHUN-WEI CHEN, TAOYUAN COUNTY (TW); SHYI-MING PAN, TAOYUAN COUNTY (TW); WEI-KANG CHENG, TAOYUAN COUNTY (TW); CHUN-CHENG LIN, TAOYUAN COUNTY (TW); JUN-FU YANG, TAOYUAN COUNTY (TW); CHIH-CHIEH WANG, TAOYUAN COUNTY (TW)

(73) Assignees: DJ AUTO COMPONENTS CORP., TAOYUAN (TW); FORMOSA EPITAXY INCORPORATION, TAOYUAN COUNTY (TW)

(21) Appl. No.: 14/268,092

(22) Filed: May 2, 2014

(30) Foreign Application Priority Data
Oct. 28, 2013 (TW) 102138973

(51) Int. Cl. F21K 99/00

(52) U.S. Cl. CPC F21K 9/50
USPC 362/84; 362/235

(57) ABSTRACT

The invention is an illumination system comprising a semiconductor light source module. The illumination system comprises a reflector comprising a curved reflective surface, a holder coupled to the reflector, and a semiconductor light source module comprising a first light-emitting unit and a second light-emitting unit. The holder comprises a second holding section and a first holding section disposed between the reflector and the second holding section. The semiconductor light-source module is disposed on the second holding section to face the curved reflective surface. An angle between at least a light-emitting unit and at least a part of the first holding section is formed and ranges from 145 to 175 degrees.

### FIELD OF THE INVENTION

The present invention relates to an illumination system, and particularly to an illumination system which can adjust illumination distance and comprises a semiconductor light source module, a corresponding holder and a reflector, wherein the semiconductor light source module comprises two or more light-emitting units.

### BACKGROUND OF THE INVENTION

High-beam and low-beam are different illumination systems and can be respectively used for different environments, such as daytime, night, or fog. In the high-beam system, the illuminating angle is higher and the projection distance is longer; oppositely, in the low-beam system, the illuminating angle is lower and the projection distance is shorter.

Take car applications for example. In the past, light sources of headlamps mainly used halogen bulbs. Due to the larger size of the bulbs, different lamp modules respectively used in the high-beam, the low-beam, or the fog headlamps are installed in independent lamp housings (containing corresponding optical lenses and mechanism devices). Therefore, the illumination system of cars should have a sufficient space for installing at least two of these lamps, such as the high-beam and the low-beam. Given this requirement, the overall size of a headlamp module is sure to be large. In addition, various accessories, including respective heat dissipating structures, larger lamp hoods, and respective secondary optical systems for enhancing the light-emitting effect, all of them increase costs of the headlamp modules.

### SUMMARY

To solve the above problems, integrate the high-beam and the low-beam to minimize size of the modules, and decrease required accessory quantities and production cost, the present invention provides an illumination system with a novel structure and excellent performance.

An objective of the present invention is to provide an illumination system, comprising a semiconductor light source module, a holder, and a reflector comprising a curved reflective surface, wherein the illumination system can emit light having different illumination distances or projecting ranges. The semiconductor light source module further comprises a circuit control unit, so that users can select different light sources via a single control console according to their demands, to activate the function of adjusting illumination distance or range.

Another objective of the present invention is to provide an illumination system, comprising a semiconductor light source module installed a plurality of light-emitting units that use the same base as the medium to disperse heat. In addition. the reflector connected with the holder reflects and outputs the light emitted from the light-emitting units, so that the light-emitting area and the required size of the illumination system are both reduced. Besides, the light-emitting effect of the illumination system of the present invention is close to the light-emitting effect of the conventional headlamp, and complies with the national standards and regulations.

For achieving the above objectives, the present invention discloses an illumination system, which comprises a semiconductor light source module, a reflector, and a holder. The reflector has a curved reflective surface. The holder connects to the reflector, and comprises a first holder section and a second holder section. The first holder section is disposed between the reflector and the second holder section. The semiconductor light source module is disposed on the second holder section to face at least a part of the curved reflective surface, and comprises two or more light-emitting units. The light-emitting units further comprise a first light-emitting unit and a second light-emitting unit. An angle between at least one of the light-emitting units and at least a part of the first holding section ranges from 145. to 175 degrees. In addition, the first and the second light-emitting units respectively comprise at least a light-emitting diode chip, and the length of the relative distance between the center of the first light-emitting unit and the center of the second light-emitting unit is equal to or less than 1.6 times the longitudinal length of the light-emitting diode chip. Accordingly, the present invention implements an integral design of a headlamp having different illumination ranges.

### BRIEF DESCRIPTION OF THE DRAWINGS

FIG. 1 shows a cross-sectional side view of the structure according to a preferred embodiment of the present invention;

FIGS. 2A to 2C show structural schematic diagrams of the semiconductor light source module according to the present invention;

FIG. 3 shows a schematic diagram of the light paths according to a preferred embodiment of the present invention;

FIG. 4 shows a schematic diagram of the paths controlled by the switch of the light-emitting units according to the present invention;

FIGS. 5A and 5B show schematic diagrams of the light paths of the headlamps of cars according to the present invention;

FIG. 6 shows a cross-sectional side view of the inverted structure according to another preferred embodiment of the present invention;

FIG. 7 shows a cross-sectional side view of the structure using a base having a slope according to another preferred embodiment of the present invention; and

FIG. 8 shows a schematic diagram of the base having a dark-colored region according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

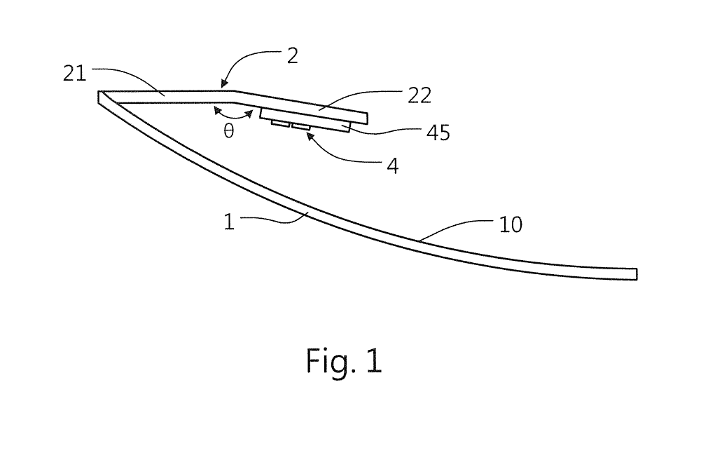

First, please refer to FIG. 1. An illumination system according to an embodiment of the present invention comprises a reflector 1, a holder 2, and a semiconductor light source module 4. A surface of the reflector 1, having the reflective function, is a curved reflective surface 10 comprising at least a curvature. The holder 2 couples to the reflector 1 and comprises a first holder section 21 and a second holder section 22. The first holder section 21 is disposed between the reflector 1 and the second holder section 22. The semiconductor light source module 4 is disposed on the second holder section 22 to face the curved reflective surface 10. A bent portion may be formed between at least a part of the second holder section 22 and at least a part of the first holder section 21. Thereby, an angle θ is formed between the part of the second holder section 22 and the part of the first holder section 21, and may range from 145 to 175 degrees. Preferably, the angle θ may range from 150 to 170 degrees. In addition, at least a part of the first holder section 21 may be parallel with the horizontal direction.

At least a part of the light emitted from the semiconductor light source module 4 is reflected by the curved reflective surface 10, and output from an opening 8 which is formed by the holder 2 and the reflector 1. According to this embodiment of the present invention, because the angle θ is formed between the second holder section 22 and the first holder section 21, the size of the opening 8 of the illumination system can be further reduced. Thereby, in contrast to the conventional headlamp technology in headlamp applications, the present invention occupies fewer area of a head of a car. Moreover, the holder 2 can be used as a blocking unit to block part of the light that reflected from the curved reflective surface 10, and to reduce the output light of the illumination system in horizontal direction, so that glare of the output light can be reduced. In addition, compared with the case without the angle θ, the location where the semiconductor light source module 4 emits light on the curved reflective surface 10 is closer to the joint between the reflector 1 and the holder 2. Thereby, the proportion of the main beam of the illumination system can be increased, and the area of the required curved reflective surface 10 can be reduced to minimize the overall size of the illumination system.

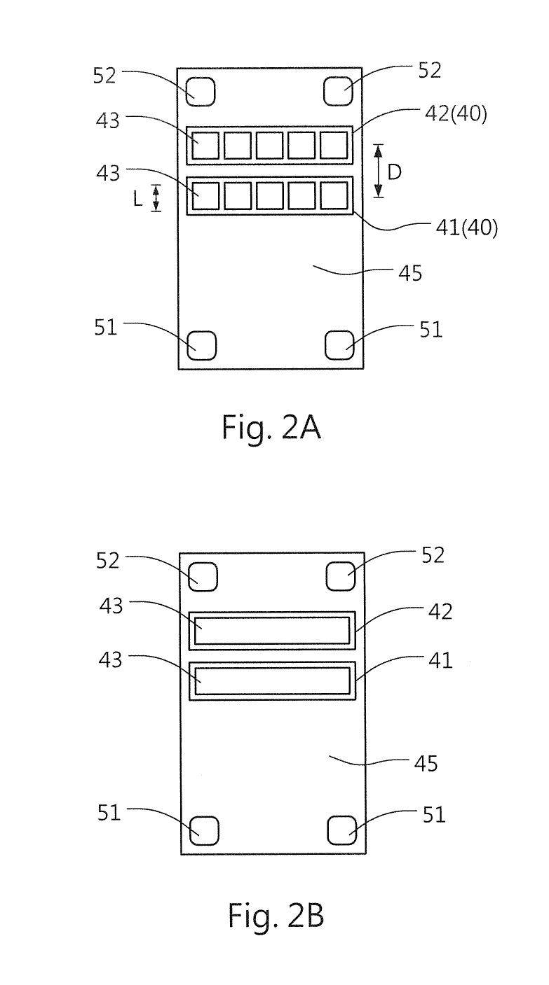

Please refer to FIG. 2A. As shown in the figure, the semiconductor light source module 4 according to an embodiment of the present invention comprises two or more light-emitting units 40 and a base 45. The light-emitting units 40 may comprises a first light-emitting unit 41 and a second light-emitting unit 42, wherein the first and the second light-emitting units 41, 42 respectively comprise light-emitting diode chips 43 with the same amount, and are disposed on the same side of the base 45. The base 45 may comprises the material of high thermal conductivity, such as metal or ceramic substrate. The luminance of the first and the second light-emitting unit 41, 42 can be different. For example, the luminance of the first light-emitting unit 41 may be stronger than the luminance of the second light-emitting unit 42. Thereby, the first and the second light-emitting units 41, 42 can be the light source of different brightness used for different illumination ranges. For instance, when the illumination range is large, the light source of stronger luminance is activated, and vice versa. In addition, according to the embodiment of the present invention shown in FIG. 1, an angle may be formed between at least one of the light-emitting units 40 and at least a part of the first holder section 21, and may be equal to the angle θ between the first and the second holder sections 21, 22.

Please refer to FIGS. 2B and 2C. In contrast to the above embodiment as shown in FIG. 2A, an embodiment is that the first and the second light-emitting units 41, 42 may respectively comprise a single light-emitting diode chip 43 as shown in FIG. 2B, or different amount of light-emitting diode chips 43 as shown in FIG. 2C. Accordingly, the luminance of the first and the second light-emitting unit 41, 42 can be different and the illumination system according to the present invention can have different brightness effect.

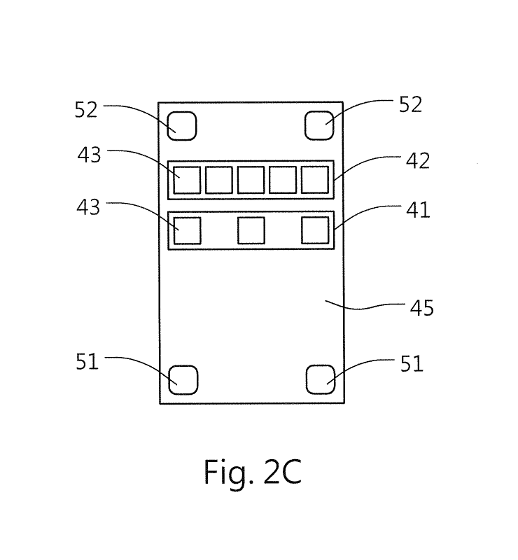

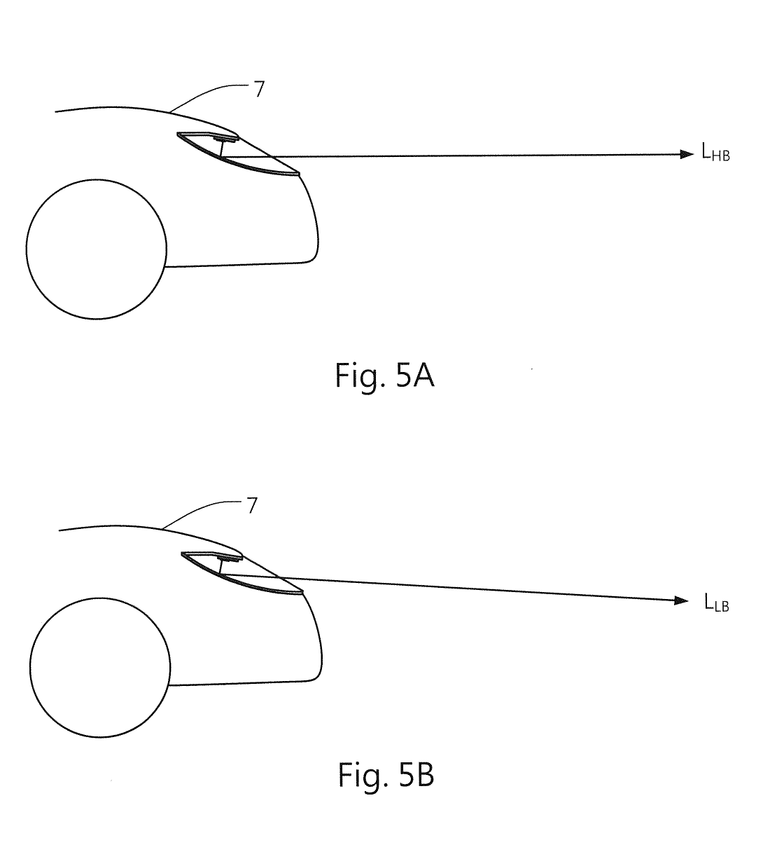

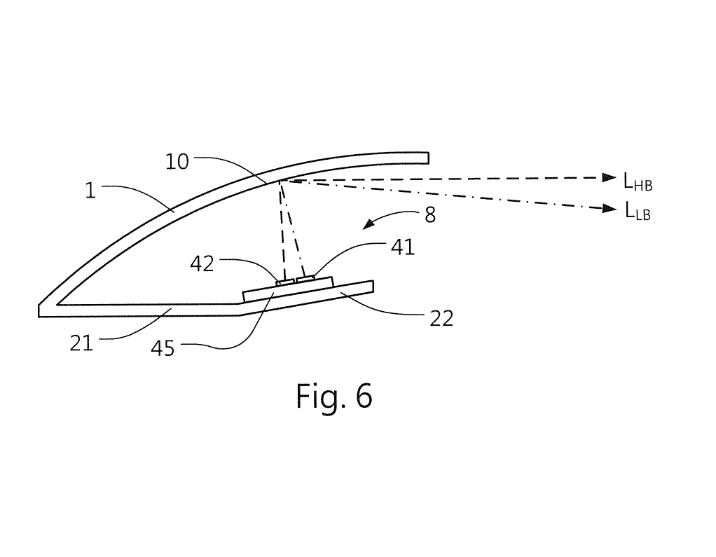

Please refer to FIGS. 2A and 3 for another embodiment of the present invention. The semiconductor light source module 4 according to the present embodiment comprises the first and the second light-emitting units 41, 42 disposed on the base 45, wherein a relative distance D exist between the center of the first light-emitting unit 41 and the center of the second light-emitting unit 42. Thereby, on the same location of the curved reflective surface 10, the incident angles of the light emitted from the light-emitting units 41, 42 are different. So that the light output through the opening 8 of the illumination system can have different transmission paths. As shown in FIG. 3, in contrast to the light L_{LB}, a path of the light L_{HB} output through the opening 8 is more away from the horizon, wherein the light L_{HB} is emitted from the first light-emitting unit 41, and the light L_{LB} is emitted from the second light-emitting unit 42. Consequently, the illuminate distance of the light L_{HB} can longer than the light L_{LB} In headlamp applications, the first light-emitting unit 41 can be used as a light source of the high-beam as shown in FIG. 5A, while the second light-emitting unit 42 can be used as a light source of the low-beam as shown in FIG. 5B; vice versa. In contrast to the embodiment shown in FIG. 3, the illumination system according to another embodiment may be upside down disposed as shown in FIG. 6, wherein the light L_{LB} is emitted from the first light-emitting unit 41, and the light L_{HB} is emitted from the second light-emitting unit 42. According to the embodiment, the first light-emitting unit 41 can be used as the light source of the low-beam, while the second light-emitting unit 42 can be used as the light source of the high-beam. In addition, according to a preferred embodiment of the present invention, the length of the relative distance D between the centers of the light-emitting units 41, 42 is equal to or less than 1.6 times the longitudinal length L of the light-emitting diode chip 43. Thereby, in headlamp applications, the size of the illumination system according to the present invention is minimized, while its illumination performance is still close to the conventional headlamp technology and complies with the national regulations of the headlamps.

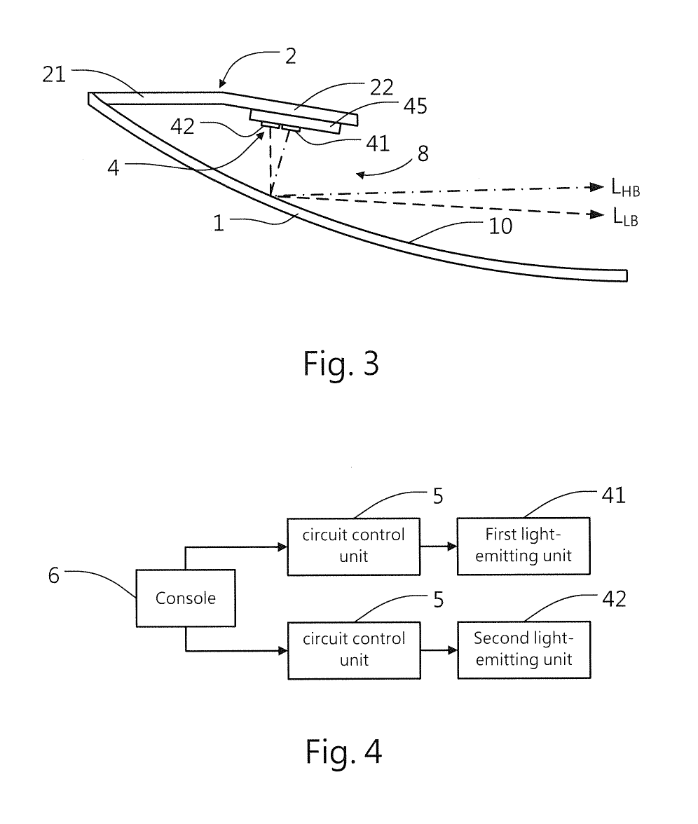

FIG. 4 shows another embodiment of the present invention. As shown in FIG. 4, the illumination system may further comprises a console 6 and two or more circuit control units 5 to control and switch the first and the second light-emitting units 41, 42 respectively, wherein the circuit control units 5 are electrically connected to the light-emitting units 41, 42. A user can give commands through the console 6 with the circuit control units 5 to control the first and the second light-emitting units 41, 42 respectively. Please refer to FIGS. 2A to 2C concurrently. The circuit control units 5 comprises a first module electrode set 51 and a second module electrode set 52, wherein the module electrode sets 51, 52 are disposed on the base 45 of the semiconductor light source module 4 and electrically connect with the first and the second light-emitting units 41, 42. According to the invention, the user can control the first and the second light-emitting units 41, 42 via a single console 6 to select desired light-emitting effects. For example, both of the first and the second light-emitting units 41, 42 can emit light simultaneously or alternatively. In addition, the circuit control units 5 of the illumination system according to the embodiment can comprises various electronic devices or can be integrated into an IC device.

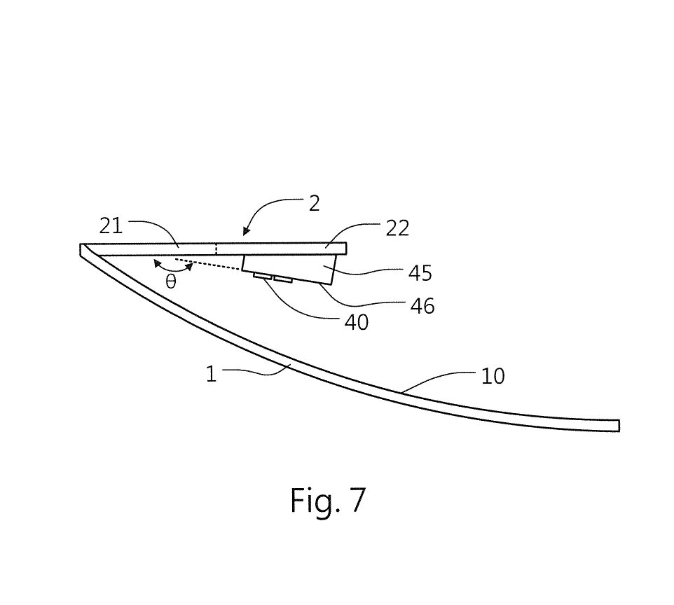

FIG. 7 shows another embodiment of the illumination system according to the present invention. Based on the above embodiments, at least a part of the surface of the base 45 of the semiconductor light source module 4, where the light-emitting units 40 disposed on, may be a slope 46. So that, an angle θ may be formed between at least one of the light-emitting units 40 and at least a part of the first holder section 21, wherein the angle θ may range from 145 to 175 degrees. Preferably, the angle θ may range between 150 and 170 degrees. According to the embodiment, the first and the second holder sections 21, 22 may connect to each other without a bent portion.

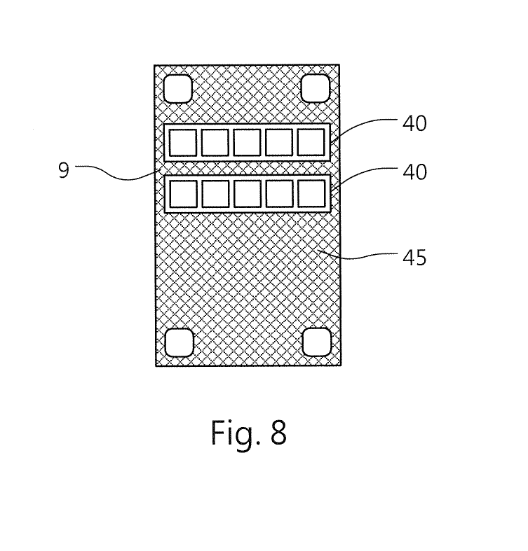

FIG. 8 shows another embodiment of the illumination system according to the present invention. Based on the above embodiments. at least a part of the surface of the base 45. where the plurality of light-emitting units 40 disposed on, comprises a dark-colored region 9 distributed around the light-emitting unit 40. Therefore, the surface of the base 45 may comprises at least a colored region or more. The dark-colored region 9 may have at least a color of the dark series. such as black, gray, dark red, dark green, dark blue. dark purple, etc., or combinations. In addition, at least a part of the surface of the holder 2, where the semiconductor light source module 4 disposed on, can also have at least a color of the dark series, such as black, gray, dark red. dark green, dark blue, dark purple, etc., or combinations. Thereby, in headlamp applications, the illumination system according to the present invention can absorb more dispersive light and have superior light-emitting performance. According to different requirements of light-emitting effect for different applications, at least a part of the surface of the base 45 where the light-emitting units 40 disposed on, or at least a part of the curved reflective surface 10, or at least a part of the surface of the holder 2 where the semiconductor light source module 4 disposed on, may have a light color or be disposed a wavelength conversion layer such as gels containing yellow, red, or green fluorescent powders.

To sum up, the present invention discloses an illumination system capable of adjusting the illumination distance or range. According to the present invention, multiple light-emitting units are disposed on the same base, so that the light-emitting units can share the base to disperse heat more efficiency and cost less. In addition, the light-emitting units illuminate on the curved reflective surface of a reflector. So that the illumination system can be applied to various fixed or mobile tools requiring different illumination distances or ranges, such as searchlights, spotlights, flashlights, bicycles, cars, motorcycles, airplanes, and ships. The present invention reduces the module size of the illumination system while maintaining the functions of the conventional illumination system. Thereby, the present invention undoubtedly provides an illumination system of practical values and capable of adjusting the illumination range.

Accordingly, the present invention conforms to the legal requirements owing to its novelty, non-obviousness, and utility. However, the foregoing description is only embodiments of the present invention, not used to limit the scope and range of the present invention. Those equivalent changes or modifications made according to the shape, structure, feature, or spirit described in the claims of the present invention are comprised in the appended claims of the present invention.

1. An illumination system comprising:
a reflector having a curved reflective surface;
a holder, coupled with said reflector, comprising a first holder section and a second holder section, wherein said first holder section disposed between said reflector and said second holder section; and
a semiconductor light source module, disposed on said second holder section to face said curved reflective surface, comprising two or more light-emitting units, wherein said light-emitting units further comprises a first light-emitting unit and a second light-emitting unit;
wherein an angle between at least one of said light-emitting units and at least a part of said first holding section ranges from 145 to 175 degrees.

2. The illumination system of claim 1, wherein said angle further ranges from 150 to 170 degrees.

3. The illumination system of claim 1, wherein said semiconductor light source module further comprises a base, and said first light-emitting unit and said second light-emitting unit are disposed on said base.

4. The illumination system of claim 1, further comprising at least a circuit control unit electrically connected with said first light-emitting unit or said second light-emitting unit.

5. The illumination system of claim 4, wherein said circuit control unit respectively connects with said first light-emitting unit and said second light-emitting unit, via a first module electrode set and a second module electrode set disposed on said base.

6. The illumination system of claim 1, wherein a wavelength conversion layer is disposed on at least a part of the surface of said curved reflective surface or at least a part of the surface of said holder.

7. The illumination system of claim 1, wherein said first light-emitting unit and said second light-emitting unit respectively comprise at least a light-emitting diode chip, and the relative distance between the centers of said light-emitting units is equal to or less than 1.6 times the longitudinal length of said light-emitting diode chip.

8. The illumination system of claim 1, wherein there is a bent portion between at least a part of said second holder section and at least a part of said first holder section to form said angle.

9. The illumination system of claim 3, wherein at least a part of the surface of said base, where said light-emitting units disposed on, is a slope to form said angle.

10. The illumination system of claim 3, wherein at least a part of the surface of said base, where said light-emitting units disposed on, comprises a dark-colored region distributed around said light-emitting units.

11. The illumination system of claim 1, wherein at least a part of the surface of said holder, where said semiconductor light source module disposed on, has at least a color of the dark series.

12. The illumination system of claim 3, wherein the surface of said base, where said light-emitting units disposed on, comprises two or more colored regions.

13. An illumination system, comprising:
a reflector having a curved reflective surface; and
a semiconductor light source module, coupled to said reflector to face said curved reflective surface, comprising two or more light-emitting units, and said light-emitting units further comprising a first light-emitting unit and a second light-emitting unit;
wherein said first light-emitting unit and said second light-emitting unit respectively comprising at least a light-emitting diode chip, and the relative distance between the centers of said first light-emitting unit and said second light-emitting unit is equal to or less than 1.6 times the longitudinal length of said light-emitting diode chip.

14. The illumination system of claim 13, further comprising a holder, coupled with said reflector, and said semiconductor light source module disposed on said holder to face said curved reflective surface.

15. The illumination system of claim 14, wherein said holder comprises a first holder section and a second holder section, said first holder section disposed between said reflector and said second holder section, and said semiconductor light source module disposed on said second holder section.

16. The illumination system of claim 14, wherein a wavelength conversion layer is disposed on at least a part of the surface of said curved reflective surface or at least a part of the surface of said holder where said semiconductor light source module disposed on.

17. The illumination system of claim 13, wherein said semiconductor light source module further comprising a base, and said first light-emitting unit and said second light-emitting unit are disposed on said base.

18. The illumination system of claim 17, wherein at least a part of the surface of said base, where said light-emitting units disposed on, comprises a dark-colored region distributed around said light-emitting units.

19. The illumination system of claim 14, wherein at least a part of the surface of said holder, where said semiconductor light source module disposed on, has at least a color of the dark series.

20. The illumination system of claim 17, wherein the surface of said base, where said light-emitting units disposed on, comprises two or more colored regions.
